(19) United States
(12) Patent Application Publication
(10) Pub. No.: US 2017/0104763 A1
(43) Pub. Date: Apr. 13, 2017

(54) PRESENTATION DEVICE AND PRESENTATION DEVICE COORDINATION

(71) Applicant: Microsoft Technology Licensing, LLC, Redmond, WA (US)

(72) Inventors: Shreyans Rai Jain, Bellevue, WA (US); Santhosh Kumar Misro, Issaquah, WA (US); Kiran Madipally, Redmond, WA (US); Sushant Singh, Redmond, WA (US)

(21) Appl. No.: 14/879,333

(22) Filed: Oct. 9, 2015

(51) Int. Cl. H04L 29/06; H04L 29/08

(52) U.S. Cl. CPC H04L 63/12; H04L 63/08; H04L 63/0421; H04L 67/141; H04L 63/10

(57) ABSTRACT

Presentation devices and establishment of communications sessions by presentation devices. Embodiments include verification that a client device has access to an authentication token that is published by a presentation device. Embodiments also include the presentation device receiving a coordinate provided by the client system, which is usable by the presentation device for establishing a connection to a particular communications session at the communications provider. Embodiments also include, based at least on the client system having access to the published authentication token, the presentation device using the coordinate to establish the connection to the particular communications session at the communications provider. Embodiments enable the client device to send control commands to the presentation device for controlling a presentation of the particular communications session, even when remote from the presentation device, and enable the presentation device to continue presenting the particular communications session even in the absence of the client device.

### BACKGROUND

Computer systems and related technology affect many aspects of society. Indeed, the computer system's ability to process information has transformed the way we live and work. For example, a staple of computer system use is facilitating communications. One manner in which computer systems facilitate communications is through use of collaborative communications sessions orchestrated by a communications provider. In these scenarios, different computer systems connect to a collaborative communications session at the communications provider, to exchange video, audio, text, etc. For example collaborative communications sessions may provide any number of collaborative features, such as shared whiteboards, shared presentations, polling, desktop sharing, audio conferencing, video conferencing, etc. An example of a collaborative communications provider is SKYPE FOR BUSINESS from MICORSOFT CORPORATION, which provides for collaborative communications sessions in the form of collaborative meetings.

In many situations, it may be desirable for a participant to join a collaborative communications session from within a conference room that includes a presentation environment (e.g., projector, display, audio equipment, etc.). Doing so can enable a plurality of users (present in the conference room) to participate together in the communications session using a single connection to the communications provider.

Conventionally, the participant connects her client device (e.g., laptop, tablet, phone, etc.) to a presentation environment in a conference room, initiates the collaborative communications session from the client device using a communications session coordinate (e.g., Uniform Resource Locator (URL), unique identifier, etc.) that was generated by or given to the participant and the participant's credentials, and performs any session-related action (e.g., muting sound, changing views, participating in polls, etc.) from the client device. Connecting the client device to a presentation environment typically involves the user plugging the client device into presentation equipment, such as a projector, television, or other display system.

Sometimes, conference room environments include a dedicated computer system that serves as the device that is connected to presentation equipment. In such environments, the dedicated computer system includes an identity itself, and is specifically invited to the communications session. For example, a meeting organizer may send a meeting invite including a communications session coordinate to each participant (e.g., by way of a calendar event or e-mail message), and may include the dedicated computer system of the conference room as one of those participants (e.g., by adding an electronic address of the dedicated computer system as an invitee). Thus, the dedicated computer system may be enabled to join the communications session on its own behalf, using its own authentication credentials.

However, these conventional mechanisms for participating in collaborative communications sessions lack flexibility, such as by requiring a user to tie up his device as a session initiator, and/or by requiring inclusion of a conference room computer in a session invite.

### BRIEF SUMMARY

At least some embodiments described herein facilitate coordinating establishment of a communications session by a presentation device with a communications provider. Embodiments include exchange of an authentication token between the presentation device and the client device, in order to validate the client device. Embodiments also include mechanisms for the presentation device to obtain a communications session coordinate from a client device, and to establish a connection to the communications session at the instruction of, or on behalf of, the client device. Communications between the presentation device and client device may be direct (e.g., peer-to-peer wireless), or may be indirect through a coordination service.

Some embodiments relate to methods, systems, and computer program products for a presentation device that coordinates with a client system to connect to a communications provider at the instruction of or on behalf of the client system. These embodiments include publishing an authentication token identifying the presentation device. These embodiments also include, based at least on publishing the authentication token, receiving one or more control commands indicating that the client system has access to the published authentication token. The one or more control commands include a coordinate provided by the client system, which is usable for establishing a connection to a particular communications session at the communications provider. These embodiments also include, based at least on the client system having access to the published authentication token, using the coordinate to establish the connection to the particular communications session at the communications provider.

Other embodiments relate to methods, systems, and computer program products for a client system that coordinates with a presentation device for connecting the presentation device to a communications provider at the instruction of or on behalf of the client system. These embodiments include receiving an authentication token published by the presentation device, and sending one or more control commands towards the presentation device. The one or more control commands indicate that the client system has access to the published authentication token, and include a coordinate that is usable by the presentation device for establishing a connection to a particular communications session at the communications provider. These embodiments also include sending one or more messages to the communications provider for facilitating establishment of a connection by the presentation device to the particular communications session at the communications provider.

Yet other embodiments relate to methods, systems, and computer program products for a coordination service computer system that coordinates communications between a presentation device and a client system. These embodiments include receiving from a presentation device an authentication token that is published by the presentation device, and receiving from a client system the authentication token that was published by a presentation device. These embodiments also include receiving from the client system a coordinate that is usable by the presentation device for establishing a connection to a particular communications session at a communications provider. These embodiments also include verifying that the authentication token received from the presentation device matches the authentication token received from the client system. These embodiments also include, based at least on verifying that the authentication token received from the presentation device matches the authentication token received from the client system, sending one or more control commands to the presentation device. The one or more control commands indicate that the client system has access to the published authentication token and including the coordinate.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture for coordinating establishment of a communications session with a communications provider;

FIG. 1B illustrates an example computing environment representing some example communications channels for coordinating establishment of a communications session by a presentation device with a communications provider;

FIG. 2 illustrates an example computing environment representing some example communications for exchanging an authentication token;

FIG. 3 illustrates an example computing environment representing some example communications for communicating a communications session coordinate to a presentation device;

FIG. 4 illustrates an example computing environment representing some example communications for establishing a communications session once a presentation device has authenticated a client device and has obtained a communications session coordinate;

FIG. 5 illustrates an example computing environment representing some example control command exchanges;

FIG. 6 illustrates an example computing environment representing multiple client device connections;

FIG. 7 illustrates a flowchart of an example method for configuring a presentation device to coordinate with a client system to connect to a communications provider at the instruction of or on behalf of the client system;

FIG. 8 illustrates a flowchart of an example method for configuring a client system to coordinate with a presentation device for connecting the presentation device to a communications provider at the instruction of or on behalf of the client system; and

FIG. 9 illustrates a flowchart of an example method for configuring a coordination service computer system to coordinate communications between a presentation device and a client system.

### DETAILED DESCRIPTION

At least some embodiments described herein facilitate coordinating establishment of a communications session by a presentation device with a communications provider. Embodiments include exchange of an authentication token between the presentation device and the client device, in order to validate the client device. Embodiments also include mechanisms for the presentation device to obtain a communications session coordinate from a client device, and to establish a connection to the communications session at the instruction of, or on behalf of, the client device. Communications between the presentation device and client device may be direct (e.g., peer-to-peer wireless), or may be indirect through a coordination service.

As will be appreciated in view of the following disclosure, the embodiments described herein provide client devices the ability to initiate a communications session (such as a collaborative meeting) at a presentation device, and to control the presentation device and the collaborative meeting, regardless of the location of the client device, proximity to the presentation device, state, and type of device the communications session is running on. For example, embodiments provide a secure means for establishing a two-way connection between a user's client device and a presentation device, regardless of physical range or hardware, and control the meeting experience at the presentation device. As another example, embodiments can enable multiple users to take control or connect to a single presentation device, and to disconnect from the presentation device without interrupting connection to the meeting by the presentation device.

As will be appreciated, the embodiments herein provide technical solutions that can enable a variety of scenarios that are not possible using conventional presentation techniques. In a first example scenario, embodiments can enable a client device to remotely cause a presentation device to join a meeting, and to disconnect without interrupting the meeting. Thus, a user is enabled to start a meeting in a conference room even before he is in the room, and can exit the meeting early without interrupting the meeting session.

In a second example scenario, embodiments can enable a user to control a meeting without being “on stage” (e.g., at the presentation device), and can enable multiple users to control the meeting simultaneously. For example, embodiments enable multiple client devices to connect to and control a presentation device at the same time. Thus, multiple users can user their own client devices to toggle various in-meeting controls (e.g., lock video spotlight, mute attendees, navigate presentation slides, manage presentable content, hide/show messages, invite participants, manage roster etc.), for the same meeting session that is being presented by a single presentation device.

In a third example scenario, embodiments can enable an authenticated client device to “pull” an unauthenticated device into a restricted/private meeting. In particular, embodiments enable a presentation device to join a particular meeting session at the instruction of, or on behalf of, an authenticated client device. This may involve the presentation device joining the meeting anonymously, the presentation device joining the meeting with an identity and by being vouched for by the client device, or the presentation device joining the meeting with the client device's identity (i.e., “on behalf of”).

In a fourth example scenario, embodiments can enable data transfer between user's devices and a presentation device, and/or between presentation devices and a remote service. Thus, for example, a user can pair client device with the presentation device and upload data like photos, text files, presentation etc. into the meeting. In another example, a presentation device can upload data present on the device, such as logs or recordings of meetings, to a remote service, without requiring a user to physically touch the presentation device.

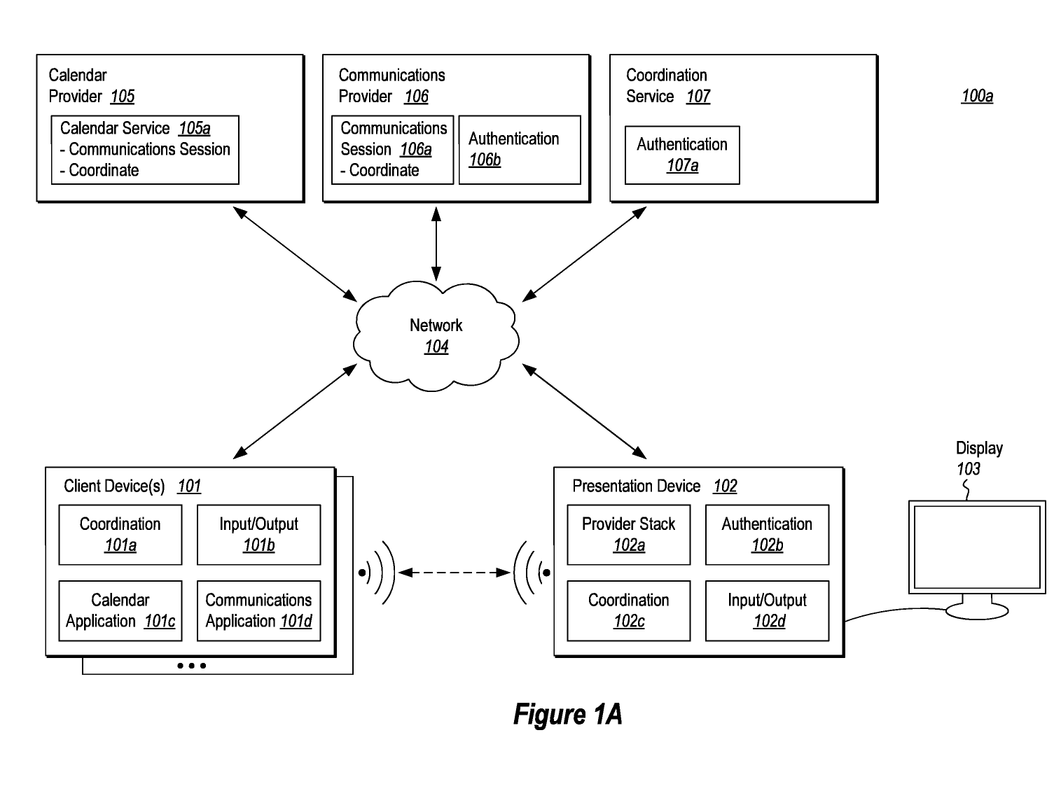

Turning now to the Figures, FIG. 1A illustrates an example computer architecture 100a for coordinating establishment of a communications session with a communications provider. Referring to FIG. 1A, computer architecture 100a may include one or more of the following: client device(s) 101, a presentation device 102, a calendar provider 105, a communications provider 106, and a coordination service 107. Each of the foregoing is connected to one another over, or is part of, a network 104. The network 104 can comprise one or more of a Local Area Network (“LAN”), a Wide Area Network (“WAN”), the Internet, etc. Accordingly, each of the devices/components can create message-related data and exchange message-related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network 104.

In some embodiments, the client device(s) 101, the presentation device 102, the calendar provider 105, the communications provider 106, and/or the coordination service 107 may be in different network trust. For example, the presentation device 102 may be the same local private network as the client device(s) 101, or they may be in different private networks. To illustrate, the presentation device 102 may be on an internal LAN or Wireless Fidelity (“WiFi”) connection, while the client device(s) 101 maybe on a public WiFi connection, a cellular connection, etc. In another example, one or more more the calendar provider 105, the communications provider 106, and the coordination service 107 may exist within different private networks, and may be reachable by the client devices 101 or the presentation device 102 (or each other) over the Internet. Alternatively, networks may be shared. For example, the coordination service 107 may be on the same network as the presentation device 102, the calendar provider 105 may be on the same network as the client device(s) 101, etc. The foregoing examples are illustrative only, and it will be appreciated that the example computer architecture 100a may embody a vast variety of network topologies and configurations.

The client devices(s) 101 can comprise any type of client computing device, such as a laptop computer, a desktop computer, a tablet, a smartphone, a wearable device, etc. As indicated by the horizontal ellipses, and as will be clarified hereinafter, the computer architecture 100a may involve use of a plurality of client devices(s) 101. As depicted, each client device 101 can include one or more of: a coordination component 101a (e.g., for coordinating with the coordination service 107 and/or the presentation device 102), a calendar application 101c (e.g., for communicating with the calendar provider 105), a communications application 101d (e.g., for communicating with the communications provider 106), and/or user input/output devices 101b. It will be appreciated that the foregoing components may be arranged in a variety of manners, including arrangements that combine one or more of the components or that entirely omit one or more of the components.

The presentation device 102 can comprise any computing system that is configured for use in a presentation environment, such as a conference room. The presentation device 102 may comprise a dedicated purpose-made hardware device, or may comprise a general-purpose computer that has been specially configured as a presentation device that operates in the computer architecture 100a. As depicted, the presentation device can be connected to presentation equipment, as represented by display 103. The presentation equipment could include, for example, a projector, a screen/display, audio equipment, room control equipment, etc. As further depicted, the presentation device 102 can include one or more of: a provider stack 102a (e.g., for communicating with the communications provider 106), an authentication component 102b (e.g., for authenticating the client device(s) 101), a coordination component 102c (e.g., for coordinating with the coordination service 107 and/or the client device(s) 101), and/or user input/output devices 201d. Again, it will be appreciated that the foregoing components may be arranged in a variety of manners, including arrangements that combine one or more of the components or that entirely omit one or more of the components.

In addition, and as depicted, the client device(s) 101 and the presentation device 102 may be capable of participating in direct peer-to-peer (i.e., antenna to antenna) communications. For example, the client device(s) 101 and the presentation device 102 may be configured to communicate with a short-range wireless protocol, such as BLUETOOTH, near-filed communications (“NFC”), or even Infrared communications. As will be appreciated in view of the disclosure herein, in some embodiments, the client device(s) 101 and the presentation device 102 can coordinate to connect the presentation device 102 to the communications provider 106 at the instruction of, or on behalf of, the client system 101 entirely over direct peer-to-peer communications, and without any use of the coordination service 107. As such, in some embodiments the computer architecture 100a omits the coordination service 107 altogether.

The calendar provider 105 can comprise any type of calendar, e-mail service, or other similar service. While not required for operation of the inventive features herein, the calendar provider 105 maybe useful to the client device(s) 101 for scheduling a communications session, such as a meeting, through the communications provider 106. For example, as depicted, calendar provider 105 provides a calendar service 105a, which in turn includes a scheduled communications session event, including a coordinate for connecting to a communications session 106a at the communications provider 106. One of ordinary skill in the art will recognize in view of the disclosure herein that a communications session may be scheduled in a variety of ways.

The communications provider 106 hosts or otherwise enables devices to connect to and participate in collaborative communications sessions, such as collaborative meetings. As depicted, the communications provider 106 hosts the communications session 106a, which is identified by a coordinate. The coordinate can be any form of an identifier (e.g., a URL or unique identifier) that can be used by devices to connect to the communications session 106a. While only a single communications session 106a is depicted, it will be appreciated that the communications provider 106 may host a great number of communications session. In addition, the communications provider 106 includes an authentication module 106b for authenticating devices that are connecting to communications sessions.

The coordination service 107 facilitates coordination of establishment of a connection to the communications session 106a by the presentation device 102 at the instruction of, or on behalf of, the client device. Thus, the coordination service 107 communicates with the coordination components 101a and 102c of the client device(s) 101 and the presentation device 107a. FIG. 1A depicts the coordination service 107 as including an authentication component 107a, though the coordination service 107 may include any number of components for providing its services.

Turning now to FIG. 1B, illustrated is an example computing environment 100b representing some example communications channels for coordinating establishment of a communications session by a presentation device with a communications provider. As depicted, the client devices 101 are configured to communicate with the calendar provider 105, the communications provider 106, and the coordination service 107 over communications channels 108a, 108b, and 108c. In addition, the presentation device 102 is configured to communicate with the communications provider 106 and the coordination service 108 over communications channels 108d and 108e. Each of communications channels 108 may occur over the network 104 of FIG. 1B. It is noted that, using communications channels 108c and 108e the client devices 101 and the presentation device 102 are enabled to communicate with each other indirectly through the coordination service 107. In addition, as depicted by the dashed arrow 109, the client devices 101 and the presentation device 102 are enabled to communicate with each other directly using a peer-to-peer wireless communications protocol, such as BLUETOOTH or NFC.

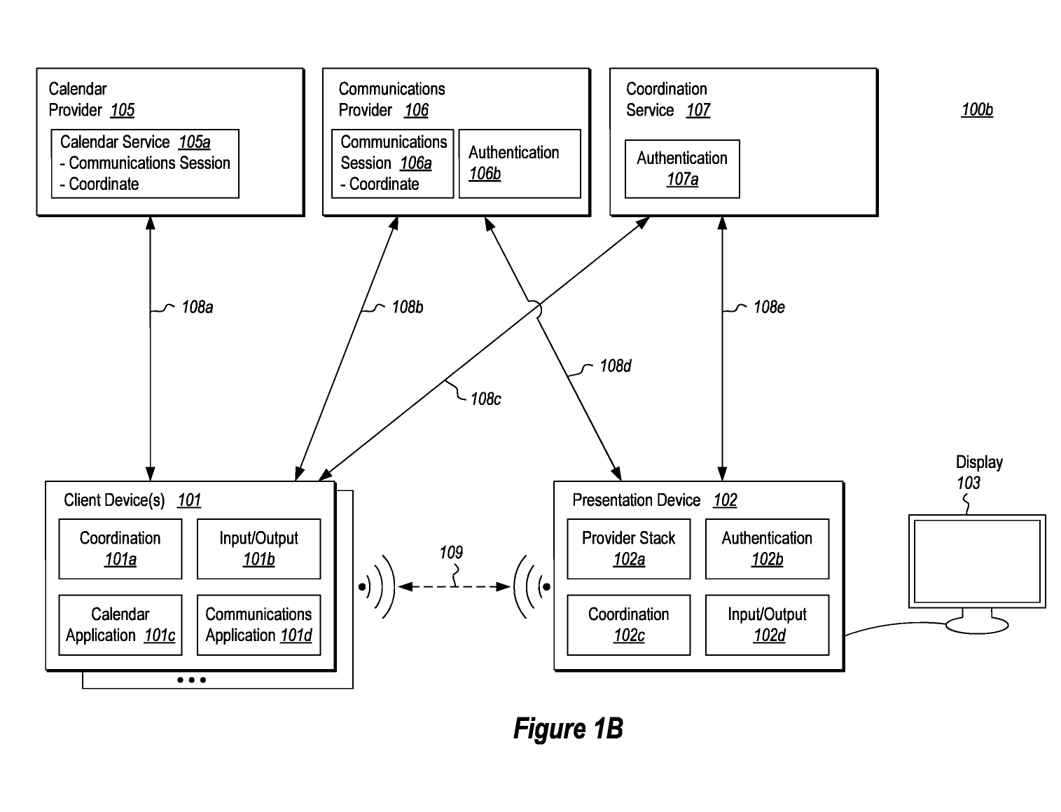

FIG. 2 illustrates an example computing environment 100c representing some example communications for exchanging an authentication token. As indicated above, embodiments provide a secure means for establishing a two-way connection between a user's client device and a presentation device. As depicted in FIG. 2, embodiments include a variety of manners for exchanging an authentication token between a client device 101 and the presentation device 102.

To begin the exchange, and without needing any foreknowledge of the client device 101, the presentation device 102 publishes an authentication token (e.g., using the coordination component 102c or the authentication component 102b), and awaits a response from the client device 101. A response from the client device 101 indicates that the client device 101 has access to the published authentication token.

The authentication token can be any form of identifier. The identifier may be periodically generated by the presentation device 102, may be an identifier that is assigned to the presentation device 102 by the coordination service 107 during an initial setup/registration of the presentation device 102, etc. In some embodiments, the authentication token comprises a personal identification number (“PIN”), such as a numeric or alphanumerical sequence, with which a human user can interact.

Publication of the authentication token may be performed using one or more of a variety publication embodiments. The presentation device 102 may simultaneously publish the authentication token using more than one, or all, of the publication embodiments.

In a first publication embodiment, the presentation device 102 causes the authentication token to be displayed at the display 103, possibly along with a name of the presentation device 102. For example, FIG. 2 illustrates a screen image 103a of the display 103, in which the presentation device 102 causes a name and a PIN to be displayed at the display 103.

In a second publication embodiment, the presentation device 102 publishes the authentication token over the network 104 to the coordination service 107. For example, FIG. 2 depicts the presentation device 102 publishing the authentication token to the coordination service 107 using message(s) 110b.

In a third publication embodiment, the presentation device 102 publishes the authentication token locally using a peer-to-peer wireless communications protocol (e.g., BLUETOOTH or NFC), such that any client device 101 that is within range can obtain the authentication token directly from the presentation device 102. For example, FIG. 2 depicts the presentation device 102 publishing the authentication token over a peer-to-peer wireless communications protocol using message(s) 110a.

Referring to the first publication embodiment, based on the authentication token having been displayed at the display 103, the coordination component 101a at the client device 101 receives the authentication token via the client device's input/output devices 101b. For example, a user may enter a conference room containing the display 103, see the authentication token on the display 103, and enter the authentication token in a coordination application on her client device 101.

After receiving the authentication token, the coordination component 101a of the client device 101 sends message(s) 112a to the coordination service 107. Message(s) 112a may identify the client device 101 and the authentication token. Upon receiving message(s) 112a, the coordination service 107 may use messages 112b to pass the identity of the client device 101 and the authentication token to the presentation device 102. The presentation device 102 can then use its authentication component 102b to authenticate the client device 101. Authentication may include verifying that the authentication token that was received from the client device 101 matches the authentication token that was published by the presentation device 102.

Additionally or alternatively, the authentication component 107a at the coordination service 107 may authenticate the client device 101, and inform the presentation device 102 of the authentication in message(s) 112b. For example, referring to the second publication embodiment, the coordination service 107 may possess the authentication token that was published by the presentation device 102 in message(s) 110b. As such, the authentication component 107a can compare the authentication token that was provided by the client device 101 in message(s) 112a with the authentication token that was provided by the presentation device 102. If they match, the authentication component 107a may cause message(s) 112b to be sent to the presentation device 102, indicating that the client device 101 has access to the published authentication token.

In either case, the coordination service and/or the presentation device 102 can send one or more message back to the client device 101 confirming or denying the authentication, as the case may be (e.g., message(s) 112d and 112c).

Referring to the third publication embodiment, based on the presentation device 102 having published its authentication token in message(s) 110a, the coordination component 101 at the client device 101 can receive the authentication token. The coordination component 101 can then cause message(s) 111a to be sent back to the presentation device 102. Messages 111a may include the identity of the client device 101 and the authentication token. The authentication component 102b at the presentation device 102 then authenticates the client device 101 (e.g. by ensuring that the authentication token received from the client device 101 matches the authentication token published by the presentation device 102). The presentation device 102 may confirm the authentication with message(s) 111b. Notably, using the third publication embodiment, the presentation device 102 can authenticate client device(s) 101 without any use of the coordination service 107.

In some embodiments, as part of authenticating a client device 101 the authentication component 102b of the presentation device 102 and/or the authentication component 107a of the coordination service 107a confirms that there is a local proximity of the client device 101 to the presentation device 102. Doing so can help ensure that only client devices 101 with some physical relation to the presentation device 102 can authenticate to the presentation device 102.

In one example, a request may be made (e.g., by the authentication component 107a or by the authentication component 102b) of any client device(s) 101 that authenticate through the coordination service 107 to provide poof of local presence. For example, the request may cause the coordination component 101a to display a prompt at the client device 101, requesting that an input be provided at the presentation device 102 (e.g., by pressing a button or other input device 102d on the presentation device 102). If such an input is provided while the prompt is being displayed, or during a defined time frame, then the client device 101 can be authenticated.

In another example, any client device 101 that authenticates over direct peer-to-peer wireless communications may automatically be verified as having a local presence, since the communications protocols used may have limited range. Of course, a request for proof of local presence (e.g., by requesting that a button on the presentation device 102 be pressed) may also be issued when a client device 101 authenticates over direct peer-to-peer wireless communications.

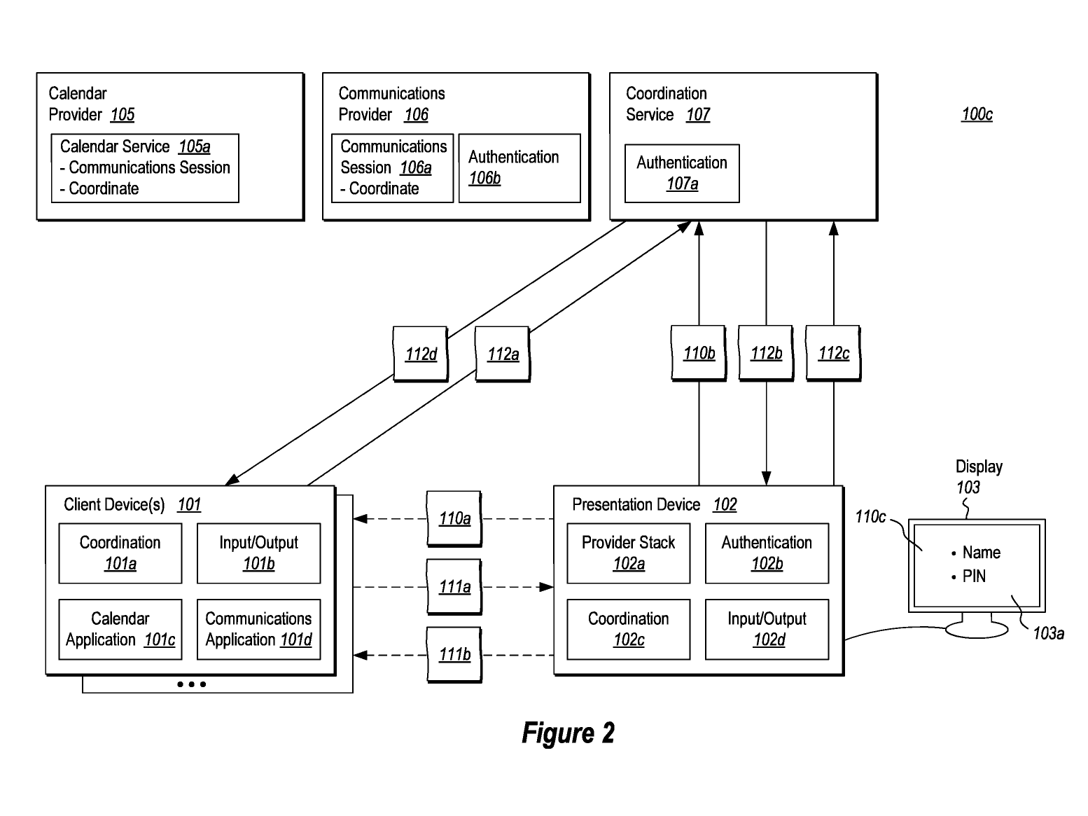

FIG. 3 illustrates an example computing environment 100d representing some example communications for communicating a communications session coordinate to a presentation device. In particular, FIG. 3 illustrates example communications paths for communicating a communications session coordinate to the presentation device 102, so that the presentation device 102 can establish a communications session with the communications provider.

The client device 101 initially obtains the communications session coordinate. As one example, FIG. 3 depicts that a calendar service 105a at the calendar provider 105 includes a calendar event for the communications session, such as a collaborative meeting, including a coordinate for stabling a connection to the communications session.

The coordinate can comprise any identifier that is usable by the client device 101 for establishing the communications session with the communications provider 106. For example, the coordinate may be a URL that is usable by the client device 101 to establish the connection, an identifier that can be provided by the client device 101 to the communications provider 106, etc.

FIG. 3 depicts that the calendar application 101c at the client device 101 may send a request 113a to obtain the calendar event, and receive the calendar event, including the coordinate, in reply 113b. Although not depicted, the client device 101 could obtain the coordinate directly from the communications provider 106, via an e-mail, or in many other manners.

Once the client device 101 has obtained the communications session coordinate, FIG. 3 illustrates that the client device 101 can communicate the coordinate to the presentation device 102 in at least two manners. In a first embodiment, the coordination component 101a at the client device 101 communicates the coordinate to the coordination component 102c at the presentation device 102 directly using a peer-to-peer wireless communications protocol using message(s) 114. As such, the client device 101 can communicate the coordinate to the presentation device 102 without use of the coordination service 107. In a second embodiment, the coordination component 101a at the client device 101 communicates the coordinate indirectly to the coordination component 102c at the presentation device 102 through the coordination service 107, as shown by message(s) 115a and 115b.

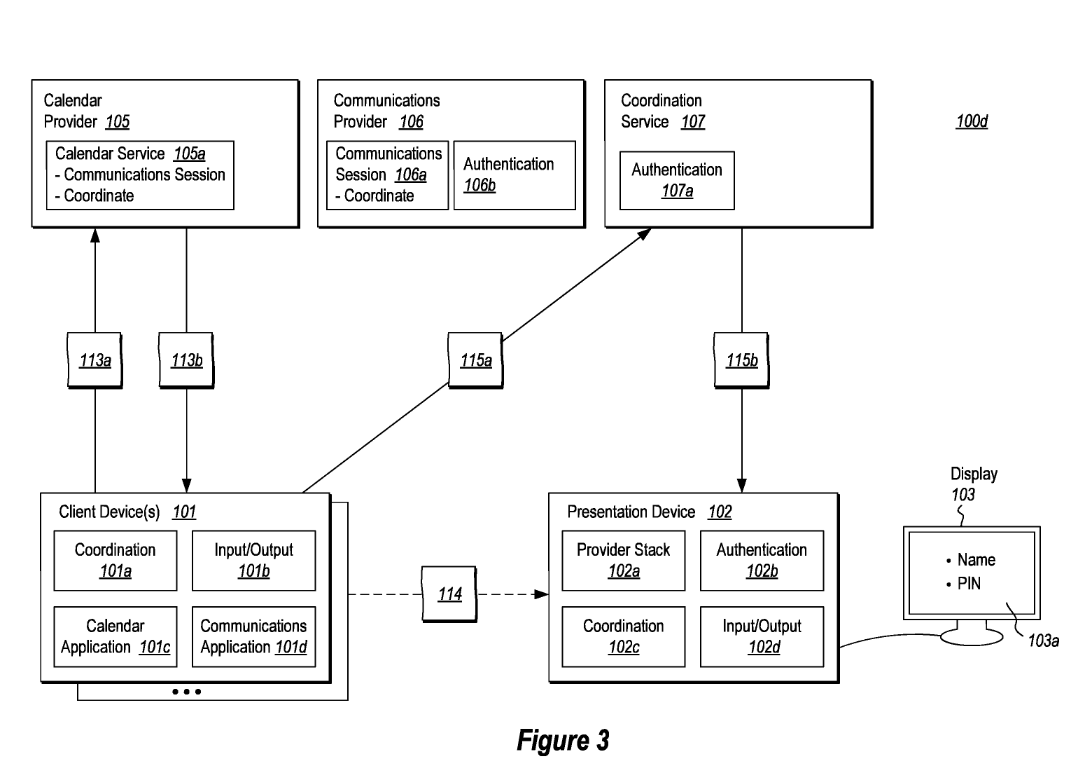

FIG. 4 illustrates an example computing environment 100e representing some example communications for establishing a communications session once a presentation device has authenticated a client device and has obtained a communications session coordinate. As indicated above, the presentation device 102 may the communications session 106a at the instruction of, or on behalf of, the client device 101.

In a first embodiment, the presentation device 102 establishes a connection to the communications session 106a anonymously, at the instruction of the client device 101. For example, the authentication module 106b at the communications provider 107 may be configured to allow anonymous connections by any device possessing a valid coordinate. Thus, the presentation device 102 can use a provider stack 102a corresponding to the communications provider to negotiate an anonymous connection to the communications session 106a corresponding to the coordinate (e.g., message(s) 117a and 117b).

In another example, the authentication module 106b at the communications provider 107 may be configured to allow anonymous connections by a device possessing a valid coordinate, if an authenticated client device 101 requests that an anonymous connection be permitted for the coordinate. Thus, the client device 101 can “pull” an anonymous device into the communications session. For example, the presentation device 102 can use the provider stack 102a to negotiate an anonymous connection to the communications session 106a corresponding to the coordinate (e.g., message(s) 117a and 117b). Additionally, the communications application 101d at the client device 110 can also authenticate to the authentication module 106b and negotiate for anonymous connections to be permitted to the communications session 106a corresponding to the coordinate (e.g., messages 116a and 116b).

In a second embodiment, the presentation device 102 establishes a connection to the communications session 106a with its own identity, at the instruction of the client device 101. For example, the authentication module 106b at the communications provider 107 may be configured to allow connections by identified devices if they are vouched for/identified by an authenticated client device 101. Thus, the client device 101 can “pull” an identified device into the communications session. For example, the presentation device 102 can use the provider stack 102a to negotiate a connection to the communications session 106a corresponding to the coordinate using its authentication token or other identifying information (e.g., message(s) 117a and 117b). Additionally, the communications application 101d at the client device 110 can also authenticate to the authentication module 106b and negotiate for connections by devices having the authentication token or other identifying information to be permitted to the communications session 106a (e.g., messages 116a and 116b).

In a third embodiment, the presentation device 102 establishes a connection to the communications session 106a with the identity of the client device 101, on behalf of the client device 101. For example, the client device 101 may share its authentication credentials for the communications provider 106 with the presentation device 102. Then, the presentation device 102 can use the provider stack 102a to negotiate a connection to the communications session 106a corresponding to the coordinate using the client device's authentication credentials, and on behalf of the client device 101 (e.g., message(s) 117a and 117b).

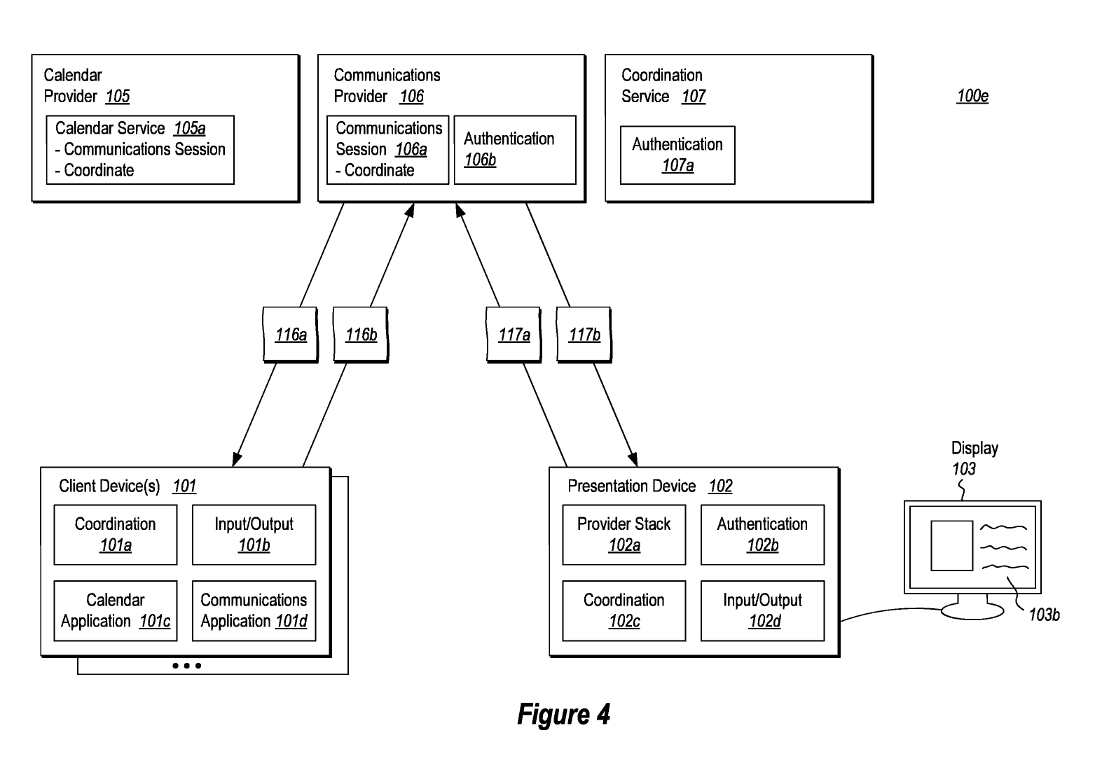

Upon establishing the communications session using any of the foregoing embodiments, the presentation device can present the communications session at the display 103 (e.g., see screen image 103b). In some embodiments, the presentation device 102 establishes a communications session with the communications provider, while the client device 101 facilitates the connection (e.g., with messages 116a and 116b), without actually establishing a communications session itself. Thus, in FIG. 5, only a single communications session connection 120, which is between the communications provider 106 and the presentation device 102, is depicted.

FIG. 5 illustrates an example computing environment 100f representing some example control command exchanges. In particular, as mentioned above, the client device 101 can send one or more control commands to the presentation device, for controlling one or more presentation device properties, such as presentation attributes of the communications session connection 120. For example, in meeting, presentation attributes may include lock video spotlight, mute attendees, navigate presentation slides, manage presentable content, hide/show messages, invite participants, manage roster etc. For example, the screen image 103b of FIG. 4 has changed to screen image 103b′ in FIG. 5, including changed display elements. Depending on functionality provided by the presentation device 102 and the presentation hardware, other controls could include dimming/raising lights, muting audio, changing volume, etc.

FIG. 5 illustrates two embodiments for sending control commands from the client device 101 to the presentation device 102. In a first embodiment, the client device 101 sends the control commands to the presentation device 102 using message(s) 118a over direct peer-to-peer communications, and may receive replies (such as confirmation of commands, status, etc.) over the direct peer-to-peer communications with message(s) 118b. In a second embodiment, the client device 101 sends the control commands to the coordination service 107 using message(s) 119b, and the coordination service 107 forwards those commands to the presentation device 102 using message(s) 119c. The presentation device 102/coordination service 107 may send reply message(s) 119d and 119a.

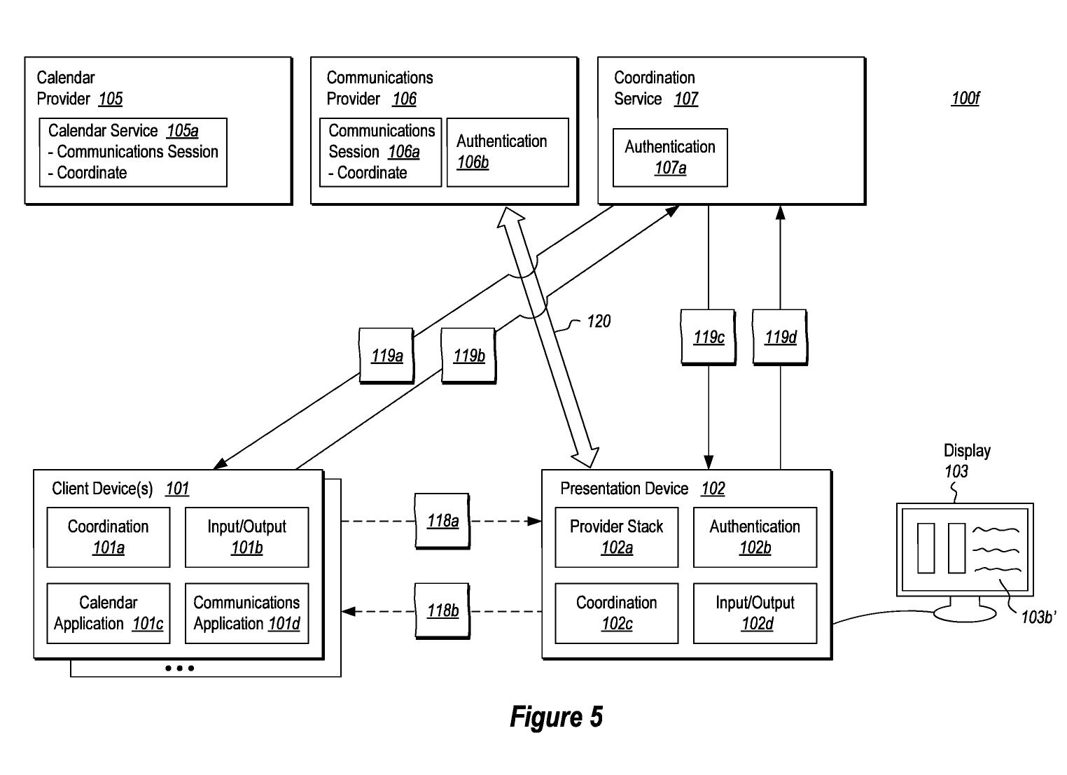

FIG. 6 illustrates an example computing environment 100g representing multiple client device connections. In some embodiments, multiple client devices 101 can authenticate with the presentation device 102 in connection with the same coordinate. Thus, each client device 101 may be enabled to send control commands to the presentation device. For example, FIG. 6 illustrates that a first client device 101′ is in communication with the presentation device 102 through the coordination service 107, and that a second client device 101″ is in communication with the presentation device 102 through peer-to-peer communications. It will be appreciated that any number of client devices may be connected using either connection mechanism.

Embodiments may include enforcing one or more polices to regulate which connected client devices 101 can control the presentation device 102 at any given time, or to limit the amount of control that a particular client device 101 has over the presentation device 102. For example, control may be assigned based on the order in which the client devices 101 connected to the presentation device 102, based on user permissions granted to users of the client devices 101, etc.

When multiple client devices 101 are authenticated, any client device 101 can drop its connection to the presentation device 102 and/or the coordination service 107 at any time. Any remaining client devices 101 can maintain their connections to the presentation device 102, and can thus still control the presentation device 102 and the communications session connection 120.

For example, even when the client device 101 that initiated the communications session connection 120 breaks its connection with the presentation device 102, the presentation device 102 can still maintain the communications session connection 120, and any other client device(s) 101 that remain connected can control the presentation device 102 and the communications session connection 120. In some embodiments, the presentation device 102 maintains the communications session connection 120, even when all the client devices 101 have disconnected. In such embodiments, the communications provider 106 may determine when to disconnect the communications session connection 120 (e.g., based on a timeout, based on the communications session 106a ending, etc.).

Having described embodiments of the invention in connection with computer architectures/environments, embodiments are now described in connection with flowcharts of example methods for performing one or more acts. It will be appreciated that in some situations the ordering of the acts may be varied, and thus the invention is not limited to the ordering presented. The example methods will be described with respect to the components computer architectures/environments 100a-100g of FIGS. 1A-6.

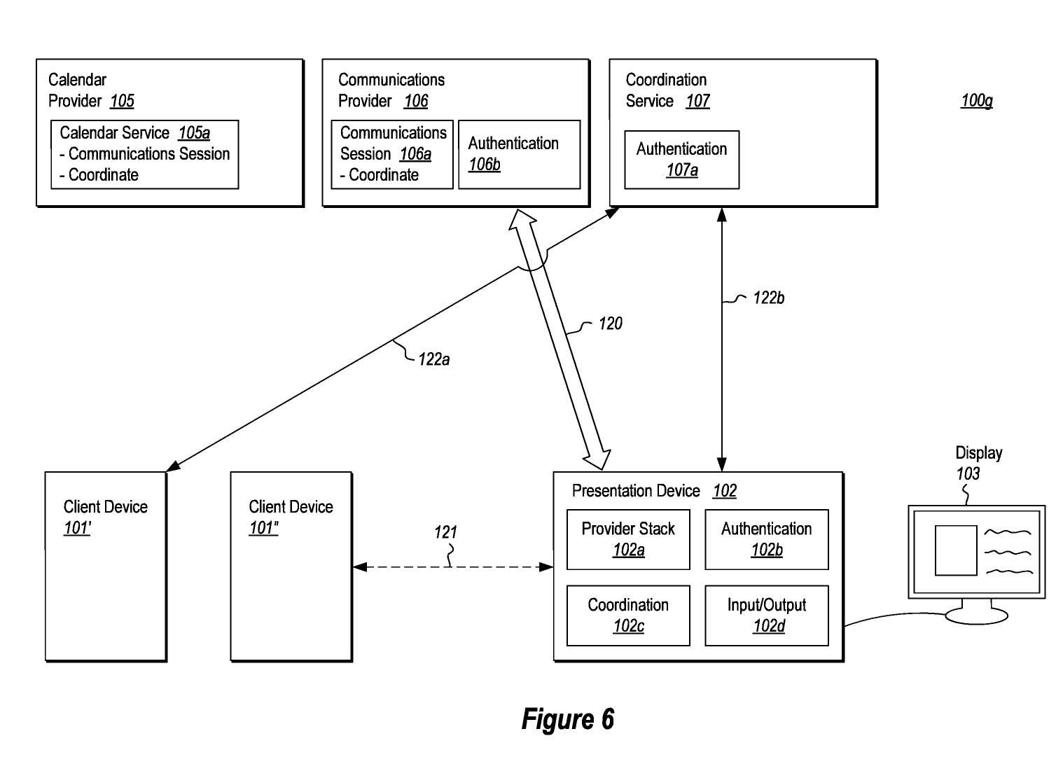

FIG. 7 illustrates a flowchart of an example method 700 for configuring a presentation device to coordinate with a client system to connect to a communications provider at the instruction of or on behalf of the client system.

Method 700 comprises an act of publishing an authentication token (act 701). Act 701 can include publishing an authentication token identifying the presentation device. For example, as depicted in FIG. 2, publishing the authentication token can include the presentation device 102 broadcasting the authentication token over a direct peer-to-peer wireless communications protocol (e.g., message(s) 110a), the presentation device 102 sending the authentication token over a network connection to the coordination service 107 (e.g., message(s) 110b), and/or the presentation device 102 displaying the authentication token at display device 103.

Method 700 also comprises an act of, based on publishing the authentication token, receiving a control command (act 702). Act 702 can include, based at least on publishing the authentication token, receiving one or more control commands indicating that the client system has access to the published authentication token, the one or more control commands including a coordinate provided by the client system and that is usable for establishing a connection to a particular communications session at the communications provider. For example, as depicted in FIGS. 2 and 3, the presentation device 102 can receive at least one control command (e.g., message(s) 111a and/or message(s) 114) directly from the client device 101 over a peer-to-peer wireless communications protocol, or receive at least one control command (e.g., message(s) 112b and/or messages 115b) indirectly through the coordination service 107. While FIGS. 2 and 3 show separate messages for receiving confirmation that the client system has access to the published authentication token and for receiving the coordinate, it will be appreciated that these messages could be combined.

Method 700 also comprises an act of using a coordinate to establish a connection to a communications session at a communications service (act 703). Act 703 can include, based at least on the client system having access to the published authentication token, using the coordinate to establish the connection to the particular communications session at the communications provider. For example, FIG. 4 illustrates establishment of a connection to the communications session 106a at the communications provider 106 using a coordinate received from the client device 101.

As described in connection with FIG. 4, using the coordinate to establish the connection to the particular communications session at the communications provider may comprise one of: establishing an anonymous connection with the communications provider 106, establishing an identified connection with the communications provider 106, or establishing a connection with the communications provider 107 using an identity of the client system 101. In establishing one or more of these connections, using the coordinate to establish the connection to the particular communications session at the communications provider may comprise establishing the connection based on the client system 101 having identified the presentation device 102 with the communications provider 106.

Method 700 may also comprise receipt of additional control commands by the presentation device 102 for controlling the communications session. For example, method 700 may include presenting one or more elements of the particular communications session at one or more hardware devices, receiving one or more additional control commands from the client system for instructing the presentation device to modify one or more presentation attributes, and modifying the one or more elements of the particular communications session according to the one or more presentation attributes. For example, FIG. 5 illustrates that control commands from the client device 101 can modify the manner of the presentation of the communications session (e.g., screen image 103b′).

Method 700 may also comprise verifying a local presence of the client system prior to using the coordinate to establish the connection to the particular communications session at the communications provider. For example, verification of local presence may include identifying that a control command indicating that the client system has access to the published authentication token was received over a peer-to-peer wireless communications protocol, or receiving a requested user input at a user input device of the presentation device.

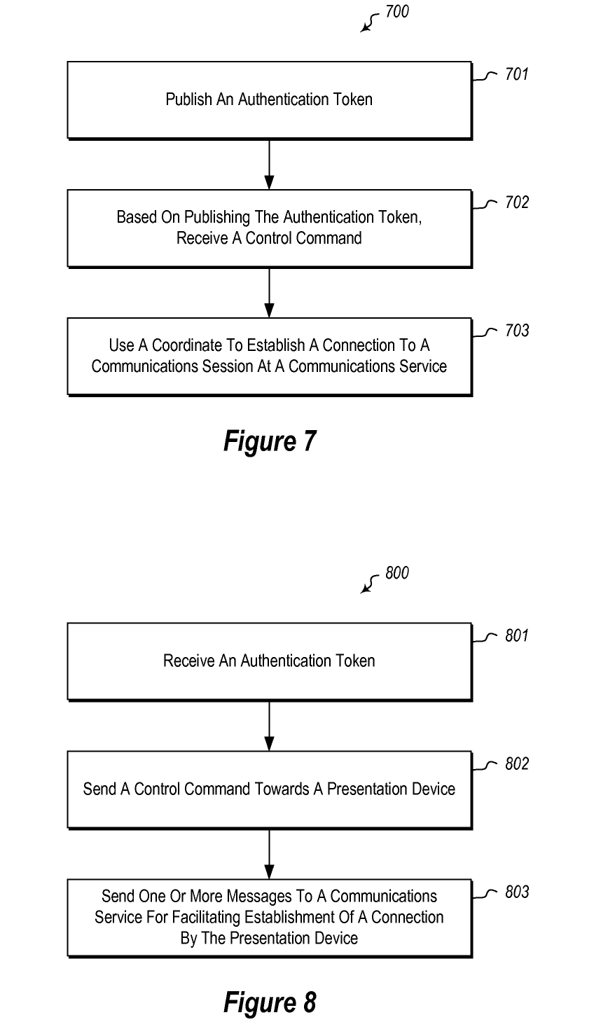

Turning to FIG. 8, illustrated is a flowchart of an example method 800 for configuring a client system to coordinate with a presentation device for connecting the presentation device to a communications provider at the instruction of or on behalf of client system.

Method 800 comprises an act of receiving an authentication token (act 801). Act 801 can include receiving an authentication token published by the presentation device. For example, as depicted in FIG. 2, the client device 101 can receive the authentication token directly from the presentation device 102 over a peer-to-peer wireless communications protocol (e.g., message(s) 110a), or receive a user input providing the authentication token at a user input device 101b.

Method 800 also comprises an act of sending a control command towards a presentation device (act 802). Act 802 can include sending one or more control commands towards the presentation device, the one or more control commands indicating that the client system has access to the published authentication token and including a coordinate that is usable by the presentation device for establishing a connection to a particular communications session at the communications provider. For example, as depicted in FIGS. 2 and 3, the client device 101 can send at least one control command (e.g., message(s) 111a and/or message(s) 114) to the presentation device 102 over a peer-to-peer wireless communications protocol, or send at least one control command (e.g., message(s) 112b and/or messages 115b) indirectly to the presentation device 102 through the coordination service 107. While FIGS. 2 and 3 show separate messages for sending confirmation that the client system has access to the published authentication token and for sending the coordinate, it will be appreciated that these messages could be combined.

Method 800 also comprises an act of sending one or more messages to the communications provider for facilitating establishment of a connection by the presentation device to the particular communications session at the communications provider. For example, as discussed in connection with FIG. 4, the client device 101 can negotiate (messages 116a and 116b) to aid the presentation device 102 in connecting to the communications session 106a at the communications provider. This can involve the client device 101 facilitating an anonymous connection with the communications provider, facilitating an identified connection with the communications provider, or facilitating a connection with the communications provider using an identity of the client system.

Method 800 may also comprise sending one or more additional control commands towards the presentation device for instructing the presentation device to modify one or more presentation attributes when presenting the particular communications session. For example, FIG. 5 illustrates that control commands from the client device 101 can modify the manner of the presentation of the communications session (e.g., screen image 103b′).

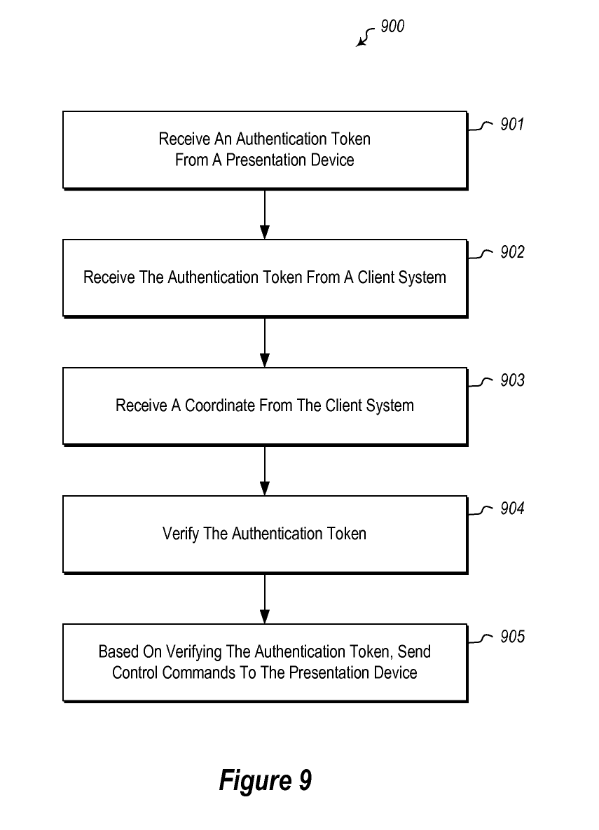

FIG. 9 illustrates a flowchart of an example method 900 for configuring a coordination service computer system to coordinate communications between a presentation device and a client system.

Method 900 comprises an act of receiving an authentication token from a presentation device (901). Act 901 can include receiving, from a presentation device, an authentication token that is published by the presentation device. For example, as depicted by FIG. 2, the coordination service 107 can receive an authentication token published by the presentation device (e.g., message(s) 110b).

Method 900 also comprises an act of receiving the authentication token from a client system (902). Act 902 can include receiving, from a client system, the authentication token that was published by a presentation device. For example, as depicted by FIG. 2, the coordination service 107 can receive an authentication token from the client device 101 (e.g., message(s) 112a).

Method 900 also comprises an act of receiving a coordinate from the client system (903). Act 903 can include receiving, from the client system, a coordinate that is usable by the presentation device for establishing a connection to a particular communications session at a communications provider. For example, as depicted by FIG. 3, the coordination service 107 can receive a coordinate from the client device 101 (e.g., message(s) 115a).

Method 900 also comprises an act of verifying the authentication token (904). Act 904 can include verifying that the authentication token received from the presentation device matches the authentication token received from the client system.

Method 900 also comprises an act of, based on verifying the authentication token, sending control commands to the presentation device (905). Act 905 can include, based at least on verifying that the authentication token received from the presentation device matches the authentication token received from the client system, sending one or more control commands to the presentation device, the one or more control commands indicating that the client system has access to the published authentication token and including the coordinate. For example, as depicted in FIGS. 2 and 3, the coordination service 107 can send at least one control command (e.g., message(s) 112b and/or message(s) 115v) to the presentation device 102. While FIGS. 2 and 3 show separate messages for sending confirmation that the client system has access to the published authentication token and for sending the coordinate, it will be appreciated that these messages could be combined.

Method 900 may also comprise routing control commands for instructing the presentation device to modify one or more presentation attributes to the presentation device. For example, method 900 may include receiving, from the client system, one or more commands for instructing the presentation device to modify one or more presentation attributes when presenting the particular communications session, and sending the one or more commands to the presentation device.

Method 900 may also comprise receiving from the presentation device, an indication of a verification of local presence at the presentation device. For example, the presentation device 102 may send message(s) 112c indicating that a physical button has been pressed at the input devices 102d, for verifying a local presence of client device 101.

Method 900 may also comprise connecting to a plurality of client devices 101, and routing control commands to the presentation device 102 from each of these client devices 101. For example, coordination service 107 to associate an additional client system with the authentication token and with the coordinate, enabling the additional client system to send one or more commands to the presentation device for modifying one or more presentation attributes for presenting the particular communications session.

Method 900 may also comprise communicating various data with the presentation device, such as diagnostic data, screen recordings, etc.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A presentation device, comprising:
one or more hardware processors; and
one or more computer-readable media having stored thereon computer-executable instructions that are executable by the one or more hardware processors to configure the presentation device to coordinate with a client system to connect to a communications provider at the instruction of or on behalf of the client system, the computer-executable instructions including instructions that are executable to configure the presentation device to perform at least the following:
publish an authentication token identifying the presentation device;
based at least on publishing the authentication token, receive one or more control commands indicating that the client system has access to the published authentication token, the one or more control commands including a coordinate provided by the client system and that is usable for establishing a connection to a particular communications session at the communications provider; and
based at least on the client system having access to the published authentication token, use the coordinate to establish the connection to the particular communications session at the communications provider.

2. The presentation device as recited in claim 1, wherein publishing the authentication token comprises one or more of:
broadcasting the authentication token over a direct peer-to-peer wireless communications protocol;
sending the authentication token over a network connection to a coordination service; and
displaying the authentication token at a display device.

3. The presentation device as recited in claim 1, wherein receiving the one or more control commands comprises at least one of:
receiving at least one control command directly from the client system over a peer-to-peer wireless communications protocol; and
receiving at least one control command indirectly through a coordination service.

4. The presentation device as recited in claim 1, wherein using the coordinate to establish the connection to the particular communications session at the communications provider comprises one of: establishing an anonymous connection with the communications provider, establishing an identified connection with the communications provider, or establishing a connection with the communications provider using an identity of the client system.

5. The presentation device as recited in claim 1, wherein using the coordinate to establish the connection to the particular communications session at the communications provider comprises establishing the connection based on the client system having identified the presentation device with the communications provider.

6. The presentation device as recited in claim 1, the computer-executable instructions including instructions that are executable to configure the presentation device to:
present one or more elements of the particular communications session at one or more hardware devices;
receive one or more additional control commands from the client system for instructing the presentation device to modify one or more presentation attributes; and
modify the one or more elements of the particular communications session according to the one or more presentation attributes.

7. The presentation device as recited in claim 1, wherein receiving the one or more additional control commands from the client system comprises at least one of:
receiving at least one additional control command directly from the client system over a peer-to-peer wireless communications protocol; and
receiving at least one additional control command from the client system indirectly through a coordination service.

8. The presentation device as recited in claim 1, the computer-executable instructions including instructions that are executable to configure the presentation device to verify a local presence of the client system prior to using the coordinate to establish the connection to the particular communications session at the communications provider.

9. The presentation device as recited in claim 1, wherein verifying the local presence of the client system comprises one or more of:
identifying that a control command indicating that the client system has access to the published authentication token was received over a peer-to-peer wireless communications protocol; and
receiving a requested user input at a user input device of the presentation device.

10. The presentation device as recited in claim 1, wherein the communications provider comprises a meeting provider, wherein the particular communications session comprises a meeting provided by the meeting provider, and wherein the coordinate comprises a Uniform Resource Locator identifying the meeting.

11. A client system, comprising:
one or more hardware processors; and
one or more computer-readable media having stored thereon computer-executable instructions that are executable by the one or more hardware processors to configure the client system to coordinate with a presentation device for connecting the presentation device to a communications provider at the instruction of or on behalf of client system, the computer-executable instructions including instructions that are executable to configure the client system to perform at least the following:
receive an authentication token published by the presentation device;
send one or more control commands towards the presentation device, the one or more control commands indicating that the client system has access to the published authentication token and including a coordinate that is usable by the presentation device for establishing a connection to a particular communications session at the communications provider; and
send one or more messages to the communications provider for facilitating establishment of a connection by the presentation device to the particular communications session at the communications provider.

12. The client system as recited in claim 11, wherein receiving the authentication token comprises:
receiving the authentication token directly from the presentation device over a peer-to-peer wireless communications protocol; or
receiving a user input providing the authentication token at a user input device.

13. The client system as recited in claim 11, wherein sending the one or more control commands towards the presentation device comprises one or more of:
sending at least one control command directly to the presentation device over a peer-to-peer wireless communications protocol; and
sending at least one control command indirectly to the presentation device through a coordination service.

14. The client system as recited in claim 11, the computer-executable instructions including instructions that are executable to configure the client system to send one or more additional control commands towards the presentation device for instructing the presentation device to modify one or more presentation attributes when presenting the particular communications session.

15. The client system as recited in claim 11, wherein sending the one or more messages to the communications provider for facilitating establishment of a connection by the presentation device comprises facilitating an anonymous connection with the communications provider, facilitating an identified connection with the communications provider, or facilitating a connection with the communications provider using an identity of the client system.

16. A coordination service computer system, comprising:
one or more hardware processors; and
one or more computer-readable media having stored thereon computer-executable instructions that are executable by the one or more hardware processors to configure the coordination service computer system to coordinate communications between a presentation device and a client system, the computer-executable instructions including instructions that are executable to configure the coordination service computer system to perform at least the following:
receive, from a presentation device, an authentication token that is published by the presentation device;
receive, from a client system, the authentication token that was published by a presentation device;
receive, from the client system, a coordinate that is usable by the presentation device for establishing a connection to a particular communications session at a communications provider;
verify that the authentication token received from the presentation device matches the authentication token received from the client system; and
based at least on verifying that the authentication token received from the presentation device matches the authentication token received from the client system, send one or more control commands to the presentation device, the one or more control commands indicating that the client system has access to the published authentication token and including the coordinate.

17. The coordination service computer system as recited in claim 16, the computer-executable instructions including instructions that are executable to configure the coordination service computer system to:
receive, from the client system, one or more commands for instructing the presentation device to modify one or more presentation attributes when presenting the particular communications session; and
send the one or more commands to the presentation device.

18. The coordination service computer system as recited in claim 16, the computer-executable instructions including instructions that are executable to configure the coordination service computer system to receive, from the presentation device, an indication of a verification of local presence at the presentation device.

19. The coordination service computer system as recited in claim 16, the computer-executable instructions including instructions that are executable to configure the coordination service computer system to associate an additional client system with the authentication token and with the coordinate, enabling the additional client system to send one or more commands to the presentation device for modifying one or more presentation attributes for presenting the particular communications session.

20. The coordination service computer system as recited in claim 16, the computer-executable instructions including instructions that are executable to configure the coordination service computer system to receive diagnostic data from the presentation device.
